(19) United States
(12) Patent Application Publication
(10) Pub. No.: US 2023/0194257 A1
(43) Pub. Date: Jun. 22, 2023

(54) OPTICAL DETECTION OF AN OBJECT IN ACCORDANCE WITH THE TRIANGULATION PRINCIPLE

(71) Applicant: SICK AG, Waldkirch (DE)

(72) Inventor: Gerhard MERETTIG, Waldkirch (DE)

(21) Appl. No.: 18/085,460

(22) Filed: Dec. 20, 2022

(30) Foreign Application Priority Data
Dec. 21, 2021 (EP) 21216205.1

(51) Int. Cl. G01C 3/10

(52) U.S. Cl. CPC G01C 3/10

(57) ABSTRACT

An optoelectronic sensor in accordance with the triangulation principle is provided for the detection of an object in a monitored zone that has a light transmitter light transmitter for transmitting light into the monitored zone, and a light receiver having a plurality of light reception elements arranged to form an array for the generation of a respective received signal from a received light spot that the light remitted at the object generates on the light receiver. The light transmitter and the light receiver form a triangulation arrangement. The optoelectronic sensor has a control and evaluation unit that is configured to determine the incidence location of the received light spot on the light receiver and to determine distance information therefrom. The control and evaluation unit has a plurality of processing channels in which respective received signals from a group of light reception elements are combined.

The invention relates to an optoelectronic sensor in accordance with the triangulation principle for the detection of an object in a monitored zone that has a light transmitter for transmitting light into the monitored zone, a light receiver having a plurality of light reception elements arranged to form a row for the generation of a respective received signal from a received light spot that the light remitted at the object generates on the light receiver, wherein the light transmitter and the light receiver form a triangulation arrangement, and that has a control and evaluation unit that is configured to determine the incidence location of the received light spot on the light receiver and to determine distance information therefrom, wherein the control and evaluation unit has a plurality of processing channels in which respective received signals from a group of light reception elements are combined. The invention further relates to a method of detecting an object in a monitored zone using optical triangulation in which light is transmitted into the monitored zone and is received again after remission at the object, wherein a respective received signal is generated in a light receiver having a plurality of light reception elements arranged to form a row from a received light spot that the remitted light generates on the light receiver, wherein the incidence location of the received light spot on the light receiver is determined and distance information is determined therefrom, and wherein respective received signals of a group of light reception elements are combined in a plurality of processing channels.

In optical triangulation, light transmitters and light receivers are arranged next to one another. The received light spot generated by a scanned object migrates in dependence on the object distance on the receiver element. The position of the received light spot thus represents a measure for the object distance. A distance measuring sensor in accordance with the triangulation principle outputs this object distance as a measurement value.

The light sensors that mask the background form a subclass. The presence of objects is recognized here and a corresponding binary switch signal is output. In this respect, the triangulation principle is utilized to generate two received signals using a light receiver spatially resolving into a near zone and a far zone. Their difference is evaluated with a switching threshold close to or equal to zero in order thus to restrict the object detection to a specific distance zone and to suppress received signals from objects outside this distance zone as a background signal. A background suppressing light sensor is disclosed, for example, in DE 197 21 105 C2, wherein here switches are provided to associate the individual elements of a spatially resolving light receiver in a variable manner with the near zone or far zone.

Sensors in accordance with the triangulation principle are typically equipped with a linear sensor that has a large number of light reception elements or pixels for the required spatial resolution. After an exposure time, the signal content of each light reception element is read, amplified, supplied to an ADC, and then digitally further processed. It would now be desirable to detect the signals with a high sampling rate and to subject them to signal preparation, for example by filters. The components and processing capacities required for this drive up the manufacturing costs, however. This can already not be performed in small sensors because the fast ADCs would generate too high a power loss.

A solution known from DE 102 31 178 A1, for example, is the combination of signals of a plurality of light reception elements. The resulting small number of processing channels then permits a fast sampling or analog and digital preparation. This is obtained, however, with a loss in spatial resolution. DE 102 31 178 A1 proposes different ways of associating the light reception elements with the processing channels. However, ultimately it lacks the solution to quickly and flexibly maintain a high spatial resolutions where it is needed in the most varied measurement situations, namely at the current, actual incidence position of the received light spot.

DE 199 62 701 A1 discloses a method of determining the position of a light spot on a photodiode array. In this respect, the size ratio between the light spot and the photodiode cells is selected such that the light spot extends at least over three adjacent photodiode cells. This allows a position determination with subpixel resolution. The document does not look at questions of signal preparation or channel combination.

A method of operating an optoelectronic sensor is described in EP 1 853 942 B1 in which the signals are sampled and are filtered for interference light suppression. As already explained, such a complex processing cannot be performed for all the light reception elements of even only a moderately high resolution receiver array.

An optoelectronic sensor for detecting object channels is known from EP 2 390 620 B1. Here, light spots are generated from two sides, are detected on a respective receiver array, and are evaluated in a comparison. The signal preparation or channel combination of the receiver arrays is again not addressed.

EP 3 379 293 B1 discloses an optoelectronic sensor that combines a switching principle and a measuring principle. For this purpose, combining processing channels are formed and the association of a processing channel is gradually varied over the receiver array in a kind of a scanning process to generate a light distribution signal spatially resolved over the receiver array. This is only conceived as occasional information additional to the switching primary function and would be much to sluggish for an actual triangulation measurement. The scanning process does not take any account of the actual position of the received light spot that can only be subsequently determined in slow cycles.

It is therefore the object of the invention to further improve the measurement with a sensor of the category.

This object is satisfied by an optoelectronic sensor in accordance with the triangulation principle to detect an object in a monitored zone and by a method of detecting an object in a monitored zone in accordance with the triangulation principle in accordance with the respective independent claim. The sensor is, for example, a triangulation sensor or a light sensor masking the background. A light transmitter transmits light into the monitored zone, preferably a light beam bundled or collimated by a transmission optics. The light returning after remission or reflection by the object generates a received light spot on a light receiver that has a plurality of light reception elements or pixels. In this respect, the light transmitter and light receiver form a triangulation arrangement, that is they are arranged and aligned in accordance with the triangulation principle such that the received light spot migrates over the light reception elements of the light receiver in dependence on the distance of the scanned object.

A control and evaluation unit determines the incidence location on the light receiver from the received signals of the light reception elements and thus acquires distance information. Depending on the embodiment of the sensor, the distance information is output as a measured distance value or, for example, as a switch signal that depends on the distance in a light sensor masking the background. Groups of light reception elements that are preferably adjacent to one another are respectively combined in a processing channel. There can be at least one processing channel here that is associated with only a single light reception element. This is then, however, an exception in which at least the further processing channels combined a plurality of light reception elements. There are in any case considerably fewer processing channels than light reception elements so that a combination, binning, or downsampling of the spatial resolution takes place. It is preferably assumed as a silent condition that one light reception element may be associated with at most one processing channel. Conversely, however, it is permitted that a light reception element is at least temporarily not associated with any processing channel at all.

The invention starts from the basic idea of using at least three processing channels that make an exact position determination of the received light spot possible. That at least one light reception element on which the center of the reception light spot is incident is associated with one of these processing channels that is called a central channel. The center can, for example, be fixed by a statistical measurement such as the focus, the maximum, or the median of the light distribution over the received light spot in the array direction of the light receiver. The light reception elements at both sides of the center are associated with a right or left flanking channel and thus detect a right or left portion of the received light spot. This association of the three processing channels with the light reception elements on which the received light spot is incident can be a, for example, calibrated or preset fixed state of the sensor. It is preferably a target state that is set or regulated dynamically over and over again. The association is thus flexible and adaptable.

The invention has the advantage that a high resolution and an improved interference light suppression with reduced noise can simultaneously be achieved. Due to the combination in processing channels, light reception elements can share a fast sampling and analog and digital signal preparation and this can also be implemented in a complex and high quality manner in comparatively simple sensors for the small number of processing channels. Thanks to the association in accordance with the invention of light reception elements with processing channels, positioning determination on the light receiver remains high resolution here. Consequently, a measurement accuracy and interference resistance is achieved that is comparable with a sensor that provides fast sampling and complex signal preparation for all the light reception elements. The invention, however, avoids the manufacturing costs and technical disadvantages associated therewith such as construction size, response time, or power consumption.

The processing channels are preferably configured for an analog and/or digital signal preparation of the received signals, in particular using an amplifier, a filter for DC light portions, an A/D converter, a smoothing filter and/or a frequency filter. A substantially more robust detection is thereby made possible. Since there are only comparatively few processing channels, it is also possible to work with more complex modules without too great an effort. An exemplary signal processing provides an amplification, a filtering of the DC light portion and, after an A/D conversion, further digital filters such as a FIR filter in the analog part.

The control and evaluation unit is preferably configured for interference filtering in at least one processing channel, with a suitable time for a signal recording in particular being determined using an observation of the interference environment. The interference filtering can be part of the signal preparation mentioned in the previous paragraph. The processing channels make it possible in this embodiment to identify dynamic interference that is therefore only present at specific times. A typical example is a sensor of the same design with its light signals. Interference synchronization by which the sensor evades such temporary interference in that the signal recording always takes place at time intervals that are as free of interference as possible can take place, for example, by the observation of the interference environment.

The received signals of the processing channels are preferably combined in an analog manner. The corresponding common received signal of the processing channel, for example a sum signal, can then be processed by components that are only required once per processing channel, for example amplifiers, analog filters, or ADCs. High quality components can thereby be used without worsening the manufacturing costs, the construction space or area requirements, or the power consumption excessively in so doing.

The central channel preferably has the highest resolution. The resolution corresponds to the group size. The fewer light reception elements are associated with a processing channel, the less spatial resolution is lost by the combination in this processing channel. The highest resolution of the central channel can be understood as relative; there is then no other processing channel having a smaller group size. It can, however, also be understood as absolute in that the group of light reception elements associated with the central channel only has a single light reception element. This is the highest possible resolution that the light receiver can produce, with an algorithmic resolution increase still remaining conceivable. Exceptionally, no real combination thus takes place in the central channel. In this case, the central channel makes it possible to flexibly associate its processing capacity, for example a high sampling rate or signal preparation, with any desired light reception element. In accordance with the invention, that light reception element on which the center of the received light spot is incident is particularly important for a triangulation.

The light reception elements associated with the central channel and the flanking channels preferably completely cover the received light spot, in particular exactly the received light spot. All the light reception elements that detect a portion of the received light spot are thus associated with the central channel and the flanking channels together. The received light spot is completely detected in these three channels. The complete coverage is initially meant in the sense of a sufficient condition; of every light reception element that registers a portion of this received light spot being associated with one of these three channels. The coverage is preferably also meant in the sense of a required condition. The received light spot is then exactly covered by the light reception elements associated with the three channels; no light reception element that is associated with the three channels only receives background light. The number of light reception elements to be covered that is required for this can be fixed in advance or determined dynamically. The received light spot is wider in the near zone of a scanned object than in the far zone. A coverage of the received light spot in the sense of a sufficient condition is therefore possible by a constant fixing on the near zone. In addition, the relationship of the received light spot with the width in dependence on the distance is determined by the sensor, its design, and its optics and is thus known or can be calibrated in advance so that an exact coverage is also possible by a fixed, now distance dependent fixing of the association. Alternatively, in a dynamic association, light reception elements can be added to a flanking channel test-wise or can be removed therefrom. Whether a light reception element is involved here on which the received light spot is incident can be determined by a comparison with the background level.

The control and evaluation unit is preferably configured to align the central channel and the flanking channels with the received light spot in that a level of the left flanking channel and of the right flanking channel is compared and, in the case of a difference going beyond a tolerance threshold, the central channel and the flanking channels are displaced in the direction of the smaller level. Figuratively speaking the flanking channels are balanced by displacing the three processing channels relative to the light receiver to hold the central channel in the center of the received light spot. Provided that the two flanking channels are now of the same width, that is a different number of light reception elements is associated with them, this can preferably be calculated out of the levels. With a balancing displacement, at least one light reception element is added to the processing channels in the displacement direction and at least one light reception element is removed against the displacement direction.

The control and evaluation unit is preferably configured to displace a constant number of light reception elements. The constant number amounts to at least one and is preferably at most as large as the group size of the three processing channels because otherwise the received light spot or at least its centering will possibly be lost. This is a very simple prescription that is, however, often sufficient in practice to align the processing channels with the received light spot.

The control and evaluation unit is preferably configured to displace a number of light reception elements that depends on the ratio or the difference of the level of the left flanking channel with respect to the right flank passage. The ratio of the levels with respect to one another or their differences are a measure for how much the received light spot is still decentered with respect to the desired alignment of processing channels. It can therefore be sensible to make the displacement dependent on this measure to achieve the desired alignment in fewer steps.

The control and evaluation unit is preferably configured to iterate the aligning. There is possibly still a level difference between the left and right flanking channels after an individual displacement step. The alignment can then be completed by iteration. Iteration here preferably includes more complex algorithms that, for example, allow the increment to become smaller or to provide, with other processes known per se from regulation technology, that the three processing channels are or remain aligned with an, also migrating or jumping, received light spot.

At least one further processing channel is preferably provided, namely a background channel on whose associated group of light reception elements the received light spot is not incident. The information on the received light spot is admittedly particularly important for triangulation; it can nevertheless be advantageous to measure the background. Corrections can be derived from this and a determination can particularly advantageously be made if there are a plurality of received light spots or if the received light spot has run out of the light reception elements that are associated with the central channel and the flanking channels.

At least one respective background channel is advantageously provided for a near zone and a far zone of the light receiver. The background is thus measured at a plurality of points, with relative differences by all means being able to be present in the near zone and far zone.

The control and evaluation unit is preferably configured for a new division of the processing channels in which groups of light reception elements are first associated with a respective processing channel over a region of the light receiver independently of the knowledge of the position of the received light spot on the light receiver. When the sensor is switched on or when a new object enters into the monitored zone, for example, information on where the received light spot is located is missing. The central channel and the flanking channels can thus not yet be associated. The light reception elements are distributed over the available processing channels for an initial search for the received light spot, the light receiver is, for example, subdivided into sections of equal width. It is conceivable that there is prior information on an assumed or actual position of the received light spot. The processing channels can then only be distributed over a corresponding region of the light receiver. This prior information can, for example, be an earlier measurement or a specific working area. The case that the received light spot has migrated into light reception elements that are associated with a background channel is a special case looked at in more detail below. In this case, the light reception elements of the background channel and not all of the light reception elements can be divided among the available processing channels to localize the received light spot more exactly.

The control and evaluation unit is preferably configured to carry out a position determination of the received light spot by means of the newly divided distribution channels and thus to at least initialize the central channel and the flanking channels. The position of the received light spot can be at least roughly estimated using the processing channels in accordance with the new division. A median, a maximum, a focus, or another statistical measure can be determined via the level in the processing channels for this purpose. The at least one light reception element found in this manner is then, for example, provisionally associated with the central channel and the neighbors at both sides of the flanking channels and remaining light reception elements with the at least one background channel where present. An improved starting configuration is thus found from which an alignment of the processing channels with respect to the received light spot can be carried out by the above-described balancing using the levels in the flanking channels, optionally after iteration.

The control and evaluation unit is preferably configured to compare the levels in the central channel and the flanking channels, on the one hand, and the levels in the at least one background channel, on the other hand, to determine whether the received light spot has migrated into the background channel and to optionally carry out a new division of the processing channels. As long as the central channel and the flanking channels are correctly aligned on the received light spot, the level in the at least one background channel remains at a noise level corresponding to the environmental light or background light. As soon as considerably more light is registered in the background channel, and indeed possibly with a simultaneous loss of level in the central channel and/or flanking channels, it is assumed that the received light spot has run out of the regulation region in which the alignment can be maintained by balancing. A new object has then, for example, entered into the monitored zone at a different distance. The background can be divided now, such as was described in the previous paragraph, to locate the received light spot again.

In some embodiments, in particular in the last two paragraphs, provisional measured values are generated in which the central channel and the flanking channels have not yet been ideally aligned with the received light spot. Such measured values can already be output to provide a particularly brief response time, for example on a use of the sensor in a fast control loop. These measured values are possibly still imprecise, but are in turn available very fast. Alternatively, the measured value output can be temporarily suspended so that only exact measured values are output after the alignment of the central channel and the flanking channels.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

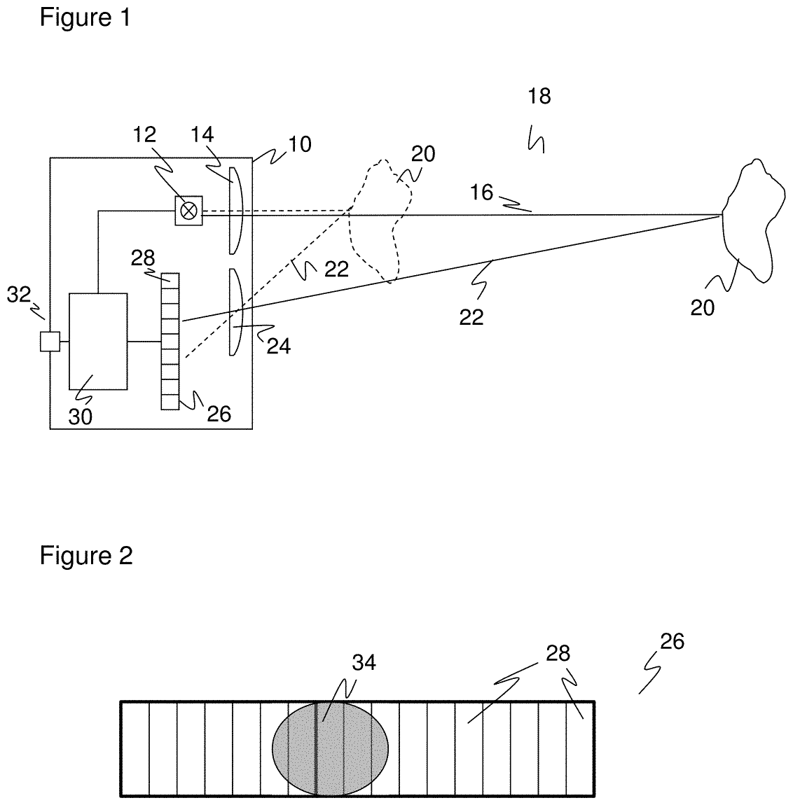

FIG. 1 a schematic sectional representation of an optoelectronic sensor in a triangulation arrangement;

FIG. 2 a schematic plan view of a light receiver with light reception elements arranged in an array and a received light spot detected thereby;

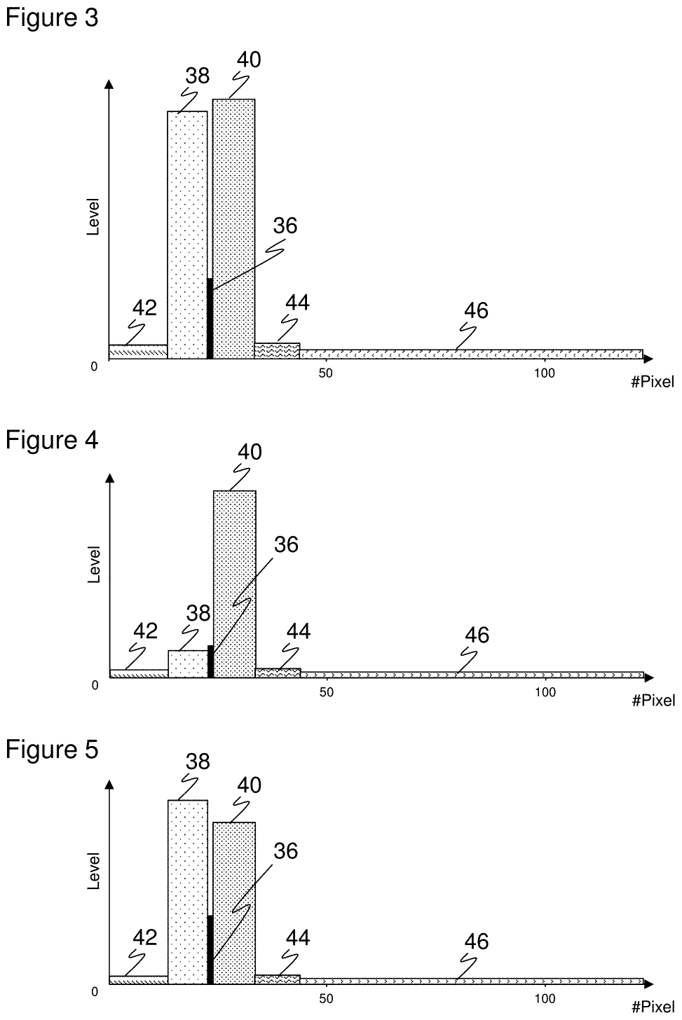

FIG. 3 a representation of the levels in a plurality of processing channels, six here, among which the light reception elements of a light receiver are divided, with, in this example, the received light spot being detected centrally by a very narrow central channel and two flanking channels of levels balanced with respect to one another;

FIG. 4 a representation similar to FIG. 3, with the alignment now having been displaced to the right;

FIG. 5 a representation similar to FIG. 4 after a correction step that again aligns the central channel and the flanking channels with the received light spot;

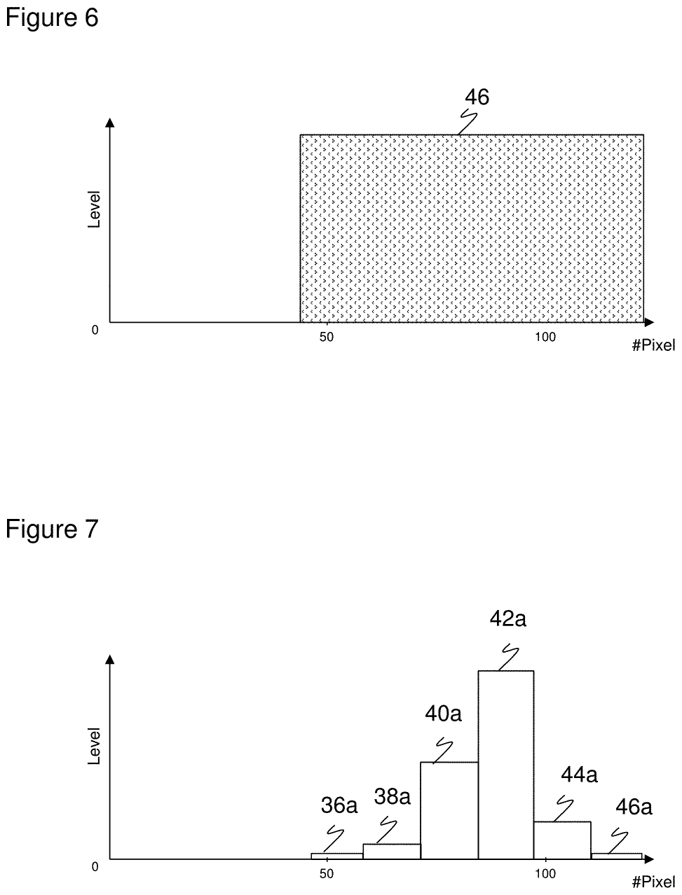

FIG. 6 a representation of the level in a background channel after the received light spot has run out of the central channel and the flanking channels in accordance with FIGS. 3-5;

FIG. 7 a representation starting from FIG. 6 in which a plurality of processing channels, six here, again share the previous background channel;

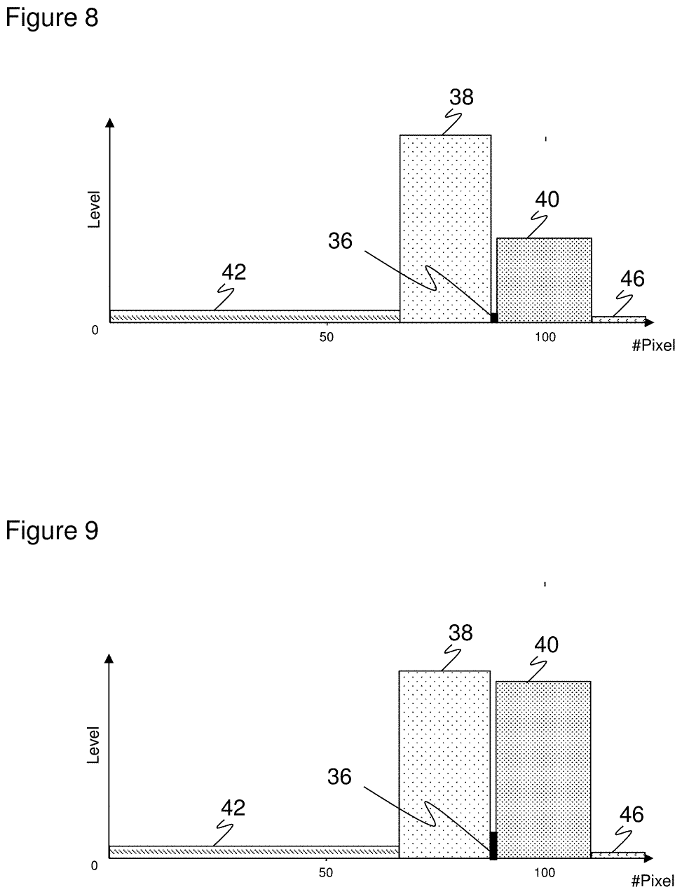

FIG. 8 a representation similar to FIG. 3 in which the central channel and the flanking channels have been fixed again and roughly aligned with the received light spot by an evaluation of the processing channels in accordance with FIG. 7; and

FIG. 9 a representation similar to FIG. 8 after a correction step analogous to FIG. 4 that now aligns the central channel and the flanking channels centrally with the received light spot;

FIG. 1 shows a schematic sectional representation of a sensor 10 in a triangulation arrangement. A typical, but not restrictive, application example is the fast object and edge detection with objects moving in from the side, for example at a conveyor belt. The sensor 10 can be a triangulation sensor that measures and outputs distances; a further example is a light sensor that masks the background as was briefly explained in the introduction that outputs a switch signal corresponding to the presence or absence of an object in a specific distance range, and that masks objects outside this distance range as a background signal. The invention is particularly advantageous for a light sensor that masks the background to set the switching distance.

A light transmitter 12 transmits a light beam 16 into a monitored zone 18 via a beam-shaping transmission optics 14. If the light beam 16 is incident on an object 20, a portion of the transmitted light returns to the sensor 10 as a remitted or reflected light beam 22. A reception optics 24 intercepts this remitted light beam 22 and conducts it to a light receiver 26 where the incident light is converted into an electrical received signal. The light receiver 26 has a plurality of pixels or light reception elements 28, in particular photodiodes, for example a number of 64 to 512 pixels. The light reception elements 28 form an array arrangement. A plurality of arrays can be provided or arrays from a matrix arrangement can be used.

Due to the triangulation arrangement, in the embodiment in accordance with FIG. 1 the offset between the light transmitter 12 with transmission optics 14 with respect to the light receiver 26 with reception optics 24 and due to the arrangement of the light reception elements 28 along the transverse connection between the light transmitter 12 and the light receiver 26, the remitted light beam 22 of a near object 20 shown by dashed lines is incident onto other light reception elements 28, further below in FIG. 1, than the remitted light beam 22 of a far object 20 shown by solid lines. The position of the received light spot, also called its deviation, offset, or displacement, that is reflected therein, which of the light reception elements 28 detects or detect the received light spot is therefore a measure of the distance of the object 20.

A control and evaluation unit 30 is connected to the light transmitter 12 for its control and to the light receiver 26 to further evaluate the electrical received signals of the light reception elements 28. In this respect, the position of a received light spot on the light receiver 26 is determined and a distance value is determined therefrom. The distance value can be output at an interface 32, with a digital interface such as an IO link or a simple analog interface such as a 4-20 mA current output being conceivable. Alternatively or additionally, a switch signal is output depending on the presence or absence of an object 20 at a distance corresponding to a foreground region.

Light reception elements 28 are combined or interconnected group-wise in processing channels for the evaluation of the received signals. A sampling or AD conversion in particular takes place in the processing channels; in addition, analog and/or digital pre-processing is possible such as amplification, filtration, noise suppression and background suppression, and the like. There are only a few processing channels; in one embodiment there are only three processing channels, in other embodiments one additional background channel or some background channels is/are added. The number of processing channels thus preferably remains at four to six or eight, at most ten, and again preferably by a factor or more below the number of light reception elements 28.

FIG. 2 shows a schematic plan view of the light receiver 26. With respect to FIG. 1, the light receiver 26 is rotated out of the plane of the paper and is additionally rotated by 90° clockwise within the plane of the paper. The remitted light beam 22 generates a received light spot 34 that is incident on some of the light reception elements 28. The association of the light reception elements 28 with processing channels is selected and adapted in accordance with the invention such that the position of the received light spot 34 can be exactly detected using a few processing channels. This channel division will be explained in more detail in the following with reference to FIGS. 3 to 9.

FIG. 3 shows a division of the reception channels that is aligned to the position of the received light spot 34. There are, purely by way of example, a total of six processing channels. The light reception elements 28 or pixels are entered on the X axis in accordance with their positions on the light receiver 26 and the energy or the level in the respective processing channel is entered in any desired unit on the Y axis, with this practically being measured, for example, by a voltage or a current.

That light reception element 28 on which a center of the received light spot 34 is incident is associated with a central channel 36. This center can be defined by a statistical measurement, for example a focus, a meridian, or a maximum of the light distribution over the received light spot 34 in the array direction of the light receiver 26. The position of the center should preferably be determined particularly exactly; the central channel 36 is therefore narrow and preferably only comprises a single light reception element 28. The level in the central channel 36 is comparatively small. This is due to the fact that only a few light reception elements 28 or even only a single light reception element 28 contribute/contributes to the central channel 36.

A left flanking channel 38 and a right flanking channel 40 are provided at both sides of the central channel 36. Those light reception elements 28 that detect the portion of the received light spot 34 to the left or right of the center are associated with the flanking channels 38, 40. This association is preferably complete in the sense that the central channel 36 and the flanking channels 38, 40 detect the total received light spot 34. No useful light is thus lost. Even more preferably, exactly the received light spot 34 is covered, i.e. no light reception element 38 on which the received light spot is not incident is moreover associated with the flanking channels. The noise is thereby limited since light reception elements 28 outside the received light spot 34 would only contribute background light. The width of the flanking channels 38, 40, that is the number of respectively associated light reception elements 28, can be specified as a constant. Alternatively, the width depends on the position on the light receiver 26 to compensate the effect that the received light spot 34 from an object 20 in the near zone is greater than in the far zone. This expected diameter of the received light spot 34 in dependence on the object distance can be calculated, simulated, or calibrated in advance for the instrument type of the sensor 10. Further alternatively, the width can be dynamically adapted to the actual received light spot 34. The flanking channels 38, 40 are preferably of equal width, that is comprise the same number of light reception elements 28. This can also depend on the definition of the center; if this is, for example, a 25% quantile, the flanks will have different widths.

The remaining light reception elements 28 only measure the background and are divided among the further processing channels. In the representation of FIG. 3, there are, purely by way of example, a respective background channel 42, 44 for the near zone and a respective background channel 46 for the far zone at both sides of the central channel 36 and the flanking channels 38, 40. The background can be taken into account in the further evaluation. Provided that a strong level is measured in a background channel 42, 44, 46, the received light spot 34 has possibly migrated onward and a new distribution of the processing channels is necessary, as will be explained later with reference to FIGS. 6 to 9.

In the aligned situation shown, the position of the received light spot 34 can now be determined with reference to the light reception elements 28 that are associated with the central channel 36 and the flanking channels 38, 40 and the level measured in these processing channels 36, 38, 40 can be determined. Such a very exact estimate of this position simply provides the identity of the light reception element 28 that is associated with the central channel 36. A somewhat more complex evaluation such as is described in DE 199 62 701 A1 named in the introduction enables an even more exact position determination with subpixel resolution, that is with even a higher accuracy than the extent of a single light reception element 28 in the array direction.

FIG. 4 shows, in a representation similar to FIG. 3, a situation in which the received light spot 34 has migrated a little to the right, that is the object 20 now has a somewhat larger distance. The central channel 36 and the flanking channels 38, 40 admittedly together still detect the received light spot 34, but the center of the received light spot 34 is no longer on the light reception element 28 of the central channel 36. The control and evaluation unit 30 can determine this because the level in the right flanking channel 40 is considerably higher than in the left flanking channel 38. This was also already the case to a certain degree in the situation of FIG. 3, but this was there due solely to the discretization effect based on the finite extent of the light reception elements 28. In the situation of FIG. 4, the difference has become larger than a tolerance and the displacement of the received light spot 32 can be recognized therefrom.

To again associate the center of the received light spot 34 with the central channel 36, the processing channels 36, 38, 40 are displaced, that is different light reception elements further to the right or left are associated with them. The levels in the flanking channels 38, 40 are graphically balanced for this purpose. Displacement can take place by one light reception element 28 or by a plurality of light reception elements 28 in one step. There should be no more light reception elements 28 than the width of the flanking channels 38, 40 since the center and possibly the total received light spot 34 would otherwise be missed. The size of the displacement step can be made dependent on the difference in the level of the two flanking channels 38, 40 or on the ratio. It is conceivable to iterate displacement steps or to implement a kind of regulation that keeps the central channel 36 on that light reception element 28 on which the center of the received light spot 34 is incident.

FIG. 6 shows a situation in which the received light spot 34 has completely migrated out of the central channel 36 and the flanking channels 38, 40. A new object 20 has, for example, entered into the monitored zone 18 at a different distance. This is shown in exaggerated form as if light were only received in the background channel 46. In reality, the remaining processing channels would at least still generate a noise signal. The control and evaluation unit 30 can at least recognize with reference to a level comparison that the main light amount is now received at a different position; the received light spot 34 is thus in a new position and a new distribution of the processing channels is necessary.

The background channel 46 is resolved again and more finely to localize the received light spot 34 within the light reception elements 28 combined in the background channel 46. The light reception elements 28 of the previous background channel 46 are in turn again divided among the available processing channels.

FIG. 7 shows the result of a signal recording after an exemplary uniform new division. A different division could be selected instead of a uniform division, for example the associated distance range can be divided uniformly, which would then result in different widths of the processing channels. The processing channels 36a, 38a, 40a, 42a, 44a, 46a have a new reference numeral with added letters and are not patterned because they only divide the earlier background channel 46 and have not yet regained their previous meaning.

The position of the received light spot 34 can already be estimated using the levels in the processing channels 36a, 38a, 40a, 42a, 44a, 46a in that, for example, the statistical measure for the center is calculated. In the situation of FIG. 7, the center must lie somewhere in the left part of the processing channel 42a. A rough distance estimation is thus already possible.

FIG. 8 shows a division of the processing channels after evaluation of the signal recording in accordance with FIG. 7. The processing channels have already regained their importance and are accordingly patterned and provided with reference numerals. The background channel 44 has been omitted since the received light spot 34 is in the far zone. This again also illustrates that the number of background channels is to be understood as exemplary. In principle in another respect, the flanking channels 38, 40 could also be subdivided again, but nothing would thereby be gained for a precise position determination so that exactly one left flanking channel 38 and one right channel 40 is preferably maintained.

However, the central channel 36 is still a little too far to the right, which can be recognized in that the levels in the flanking channels 38, 40 have still not been balanced. The first rough distance estimate can nevertheless already be considerably improved by this intermediate result. The received light spot 34 is also generally located again; only a fine alignment analogous to the explanations on FIGS. 4 and 5 is still missing. This can be expressed such that the system has again been brought into the regulation range by a new initialization, with the new initialization being limited to the range of the earlier background channel 46.

FIG. 9 again shows the regulated state after the association of the central channel 36 with the light reception element 28 on which the center of the received light spot 34 is incident has been reestablished by one or more iterated displacements of the central channel 36 and the flanking channels 38, 40. The distance value can now be precisely output.

Analogously to the described locating of the received light spot 34 in the previous background channel 46 again, the received light spot 34 can initially be located, for example on the switching on of the sensor 10. The processing channels then share all the light reception elements 28 or a working area; otherwise the procedure is as described.

In accordance with the invention, new, possibly still a little imprecise measured values can be provided even in the still unaligned state or during the alignment. Depending on the embodiment, these distance values are output directly to achieve short response times. A plurality of the last determined distance values can, however, also be evaluated and a change of the output value only takes place under this condition, for example by a majority decision or a mean value formation. In a specific example, an output change could only take place on an evaluation of the last six measurement results if at least two measurement results are larger or smaller than the current output value. Individual measurement errors, caused, for example, by EMC interference, flash light, or a fly in the light beam, can thereby be avoided.

1. An optoelectronic sensor in accordance with the triangulation principle for the detection of an object in a monitored zone, the optoelectronic sensor comprising:
a light transmitter for transmitting light into the monitored zone,
a light receiver having a plurality of light reception elements arranged to form a row for the generation of a respective received signal from a received light spot that the light remitted at the object generates on the light receiver, wherein the light transmitter and the light receiver form a triangulation arrangement, and
a control and evaluation unit that is configured to determine the incidence location of the received light spot on the light receiver and to determine distance information therefrom, wherein the control and evaluation unit has a plurality of processing channels in which respective received signals from a group of light reception elements are combined,
wherein at least three processing channels are provided, namely a central channel on whose associated group of light reception elements the center of the received light spot is incident, a right flanking channel on whose associated group of light reception elements a right portion of the received light spot is incident, and a left flanking channel on whose associated group of light reception elements a left portion of the received light spot is incident.

2. The optoelectronic sensor in accordance with claim 1,
wherein the received signals of the processing channels are merged in an analog manner.

3. The optoelectronic sensor in accordance with claim 1,
wherein the central channel has the highest resolution.

4. The optoelectronic sensor in accordance with claim 3,
wherein the group of light reception elements associated with the central channel only has a single light reception element.

5. The optoelectronic sensor in accordance with claim 1,
wherein the light reception elements associated with the central channel and the flanking channels completely cover the received light spot.

6. The optoelectronic sensor in accordance with claim 5,
wherein the light reception elements associated with the central channel and the flanking channels completely cover exactly the received light spot.

7. The optoelectronic sensor in accordance with claim 1,
wherein the control and evaluation unit is configured to align the central channel and the flanking channels on the received light spot in that a level of the left flanking channel and of the right flanking channel is compared and, in the case of a difference going beyond a tolerance threshold, the central channel and the flanking channels are displaced in the direction of the smaller level.

8. The optoelectronic sensor in accordance with claim 7,
wherein the control and evaluation unit is configured to displace a constant number of light reception elements.

9. The optoelectronic sensor in accordance with claim 7,
wherein the control and evaluation unit is configured to displace a number of light reception elements that depends on the ratio or the difference of the level of the left flanking channel with respect to the right flank passage.

10. The optoelectronic sensor in accordance with claim 7,
wherein the control and evaluation unit is configured to iterate the alignment.

11. The optoelectronic sensor in accordance with claim 1,
wherein at least one further processing channel is provided, namely a background channel on whose associated group of light reception elements the received light spot is not incident.

12. The optoelectronic sensor in accordance with claim 11,
wherein at least one respective background channel is provided for a near zone and a far zone of the light receiver.

13. The optoelectronic sensor in accordance with claim 1,
wherein the control and evaluation unit is configured for a new division of the processing channels in which groups of light reception elements are first associated with a respective processing channel over a region of the light receiver independently of the knowledge of the position of the received light spot on the light receiver.

14. The optoelectronic sensor in accordance with claim 13,
wherein the control and evaluation unit is configured to carry out a position determination of the received light spot by means of the newly divided distribution channels and thus at least to initialize the central channel and the flanking channels.

15. The optoelectronic sensor in accordance with claim 14,
wherein at least one further processing channel is provided, namely a background channel on whose associated group of light reception elements the received light spot is not incident and wherein the control and evaluation unit is configured to compare the levels in the central channel and the flanking channels, on the one hand, and the levels in the at least one background channel, on the other hand, to determine whether the received light spot has migrated into the background channel.

16. The optoelectronic sensor in accordance with claim 15,
wherein the control and evaluation unit is further configured to carry out a new division of the processing channels.

17. The optoelectronic sensor in accordance with claim 1, wherein the control and evaluation unit is configured for interference filtering in at least one processing channel.

18. The optoelectronic sensor in accordance with claim 17, wherein a suitable time for a signal recording is determined using an observation of the interference environment.

19. A method of detecting an object in a monitored zone using optical triangulation in which light is transmitted into the monitored zone and is received again after remission at the object, wherein a respective received signal is generated in a light receiver having a plurality of light reception elements arranged to form a row from a received light spot that the remitted light generates on the light receiver, wherein the incidence location of the received light spot on the light receiver is determined and distance information is determined therefrom, and wherein respective received signals of a group of light reception elements are combined in a plurality of processing channels,
wherein at least three processing channels are provided, namely a central channel on whose associated group of light reception elements the center of the received light spot is incident, a right flanking channel on whose associated group of light reception elements a right portion of the received light spot is incident, and a left flanking channel on whose associated group of light reception elements a left portion of the received light spot is incident.
